(19) United States
(12) Patent Application Publication
(10) Pub. No.: US 2005/0219967 A1
(43) Pub. Date: Oct. 6, 2005

(54) Method for controlling optical disk driver in response to ejecting command

(75) Inventor: Ye Changqing, Su Zhou City (CN)

Correspondence Address: Ladas & Parry, Suite 2100, 5670 Wilshire Boulevard, Los Angeles, CA, 90036, US

(73) Assignee: BENQ CORPORATION

(21) Appl. No.: 11/096,559

(22) Filed: Apr. 1, 2005

(30) Foreign Application Priority Data
Apr. 2, 2004 (TW) 093109316

(51) Int. Cl. G11B 7/085

(52) U.S. Cl. 369/30.27

(57) ABSTRACT

The invention provides a method for controlling an optical disk driver in response to an ejecting command request. If the optical disk driver is equipped with a tray, the ejecting command requests the tray to be ejected out of the optical disk driver. If the optical disk driver is equipped with a lid, the ejecting command requests the lid to be rotated from a closed position to an open position with respect to the optical disk driver. The method according to the invention can significantly reduce the response time to the ejecting command.

### BACKGROUND OF THE INVENTION

1. Field of the Invention

The present invention relates to a method for controlling an optical disk driver, especially to a method for controlling the optical disk driver in response to an ejecting command. The ejecting command requests the optical disk driver to change from a closed state to an open state, wherein the closed state represents an optical disk being disposed within the optical disk driver and capable of being driven, and the open state represents that the optical disk can be taken out by a user. In other words, if the optical disk driver is equipped with a tray, the ejecting command requests the tray to eject out of the optical disk driver. If the optical disk driver is equipped with a lid, the ejecting command requests the lid to rotate from a closed position to an open position with respect to the optical disk driver.

2. Description of the Prior Art

The optical disk driver is a player used for driving various optical disks, e.g. the player for displaying/recording data from/in MO-disc, CD-R, CD-ROM, CD-RAM, CD-RW, DVD-R, DVD-RW, DVD+R, DVD+RW, DVD-ROM, DVD-RAM, blue ray disk (BD), advance video disk (AOD), HD-DVD, and so on.

A typical optical disk driver 10 is shown in FIG. 1A. The optical disk driver is equipped with a tray 16. The optical disk driver also comprises a spindle motor 12 and an optical pick-up unit (OPU) 14. The spindle motor 12 is used for driving an optical disk 18, which is disposed within the optical disk driver, to rotate. The OPU 14 Is used for retrieving data recorded on the optical disk 18 or for recording data on the optical disk 18.

In general, once the optical disk driver 10 receives the ejecting command while being in operation, the optical disk driver 10 starts to brake the spindle motor 12, retract the OPU 14, and eject the tray 16, as shown in FIG. 1B. On the other hand, if the optical disk driver is equipped with a lid, and once the optical disk driver receives the ejecting command while being in operation, the optical disk driver starts to brake the spindle motor, retract the OPU, and open the lid.

However, the prior art about the method for controlling an optical disk driver in response to an ejecting command puts more attention on how to brake the spindle motor. For example, a reverse voltage is added to decelerate the spindle motor. Or the prior art puts more attention on how to retract the OPU. For example, the OPU is moved to and stays at a position away from the spindle motor via calculation or through an examining element. Or the prior art puts more attention on the mechanism or the voltage control for moving the tray or rotating the lid.

The related prior arts about optical disk driver, being in operation, for braking the spindle motor, for retracting the OPU, and for ejecting the tray out of the optical disk driver or opening the lid are listed in the following: U.S. Pat. No. 4,979,048, U.S. Pat. No. 5,504,402, U.S. Pat. No. 5,715,157, U.S. Pat. No. 6,449,233, U.S. Pat. No. 6,621,784, and U.S. Pat. No. RE38,226. The related prior arts will not be described in detail in this specification.

After the typical optical disk driver receives the ejecting command in operation, the steps of braking the spindle motor, retracting the OPU, and ejecting the tray or opening the lid are substantially the same with the steps shown in FIG. 2. As shown in FIG. 2, in step S20, the optical disk driver first receives an ejecting command. Then, in step S22, the spindle motor is braked continually. In step S24, the condition of whether the spindle motor is still is detected. If it is a NO in step S24, i.e. the spindle motor is not still yet, step S24 is repeated for the next detection cycle. If it is a YES in step S24, i.e. the spindle motor is still, step S26 is performed. In step S26, the OPU is retracted. After step S26, step S28 is performed to eject the tray out of the optical disk driver or to rotate the lid from a closed position to an open position. Then, the whole cycle of control steps in response to the ejecting command is completed.

In the above mentioned control steps, the needed time is substantially the same with the total time for braking the spindle motor to be still, retracting the OPU, and ejecting the tray out of the optical disk driver or opening the lid. However, for the method of the prior art for controlling the optical disk driver in response to the ejecting command, the OPU is retracted only after the spindle motor becomes completely still, so that will take up a lot of time. In general, the above-mentioned step S28 is repeated. The number of times for repeatedly detecting whether the spindle motor is still will achieve 60 times or even 100 times, so the time to run all the steps, i.e. response time, for controlling the optical disk driver in response to the ejecting command takes up to several seconds or even 10 seconds.

Therefore, the objective of the present invention is to provide a method for controlling an optical disk driver in response to an ejecting command and for reducing the time needed by the whole cycle of control steps.

### SUMMARY OF THE INVENTION

The present invention provides a method for controlling an optical disk driver in response to an ejecting command. If the optical disk driver is equipped with a tray, the ejecting command requests the tray to eject out of the optical disk driver. If the optical disk driver is equipped with a lid, the ejecting command requests the lid to rotate from a closed position to an open position with respect to the optical disk driver. The optical disk driver also comprises a spindle motor and an optical pick-up unit (OPU). According to a preferred embodiment of the present invention, the optical disk driver first receives an ejecting command. A flag (F) is set immediately to be equal to a first predetermined value. Then, the flag is judged whether it is equal to a second predetermined value, and if it is a YES, the OPU is retracted. Then, an operation is performed on the flag. The spindle motor is then detected if it is still. If it is a NO in the above detection step, the step of judging if the flag is equal to the second predetermined value through the step of detecting if the spindle motor is still are repeated. If it is a YES in the above detection step, the tray seated within the optical disk driver is ejected out of the optical disk driver, or the lid is driven to rotate form the closed position to the open position with respect to the optical disk driver.

The advantage and spirit of the invention may be understood by the following recitations together with the appended drawings.

### BRIEF DESCRIPTION OF THE APPENDED DRAWINGS

FIG. 1A and FIG. 1B are the schematic diagrams of a typical optical disk driver 10 equipped with a tray 16, and the tray 16 is ejected out of the optical disk driver 10 in response to an ejecting command.

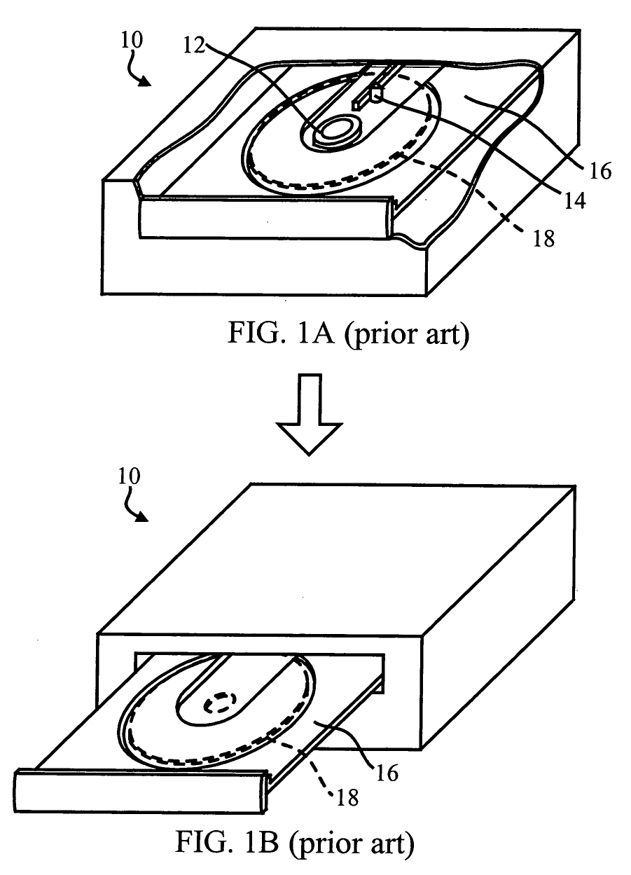

FIG. 2 is a flowchart of the method according to the prior art for controlling the optical disk driver in operation in response to an ejecting command.

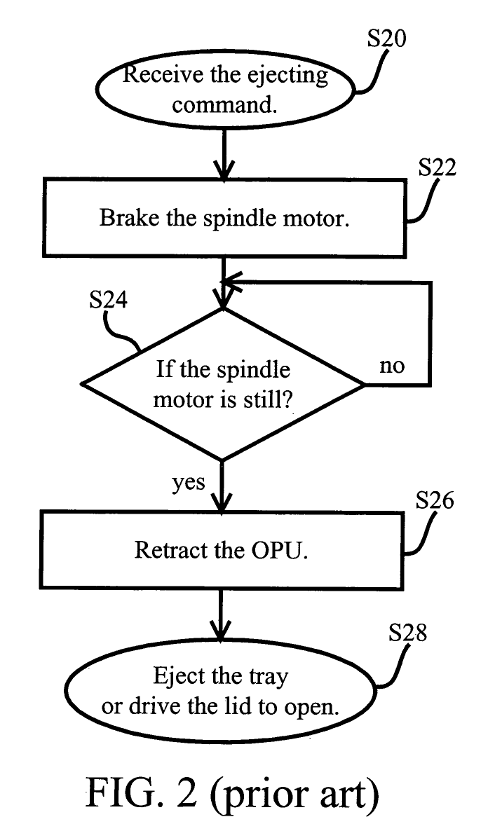

FIG. 3 is a flowchart of the method of a preferred embodiment according to the present invention for controlling the optical disk driver in operation in response to an ejecting command.

### DETAILED DESCRIPTION OF THE INVENTION

The present invention provides a method for controlling an optical disk driver in response to an ejecting command. As in typical optical disk driver, the optical disk driver, according to the method of the present invention, also comprises a spindle motor, an optical pick-up unit (OPU), and a tray (or a lid). If the optical disk driver is equipped with a tray, the tray is movably seated within the optical disk driver. If the optical disk driver is equipped with a lid, the lid is pivotally mounted onto the optical disk driver. It should be emphasized that the ejecting command requests the optical disk driver to change from a closed state to an open state, wherein the closed state represents an optical disk that is disposed within the optical disk driver and is capable of being driven, and the open state represents the optical disk that can be taken out by a user. In other words, if the optical disk driver is equipped with a tray, the ejecting command requests the tray to eject out of the optical disk driver. If the optical disk driver is equipped with a lid, the ejecting command requests the lid to rotate from a closed position to an open position with respect to the optical disk driver.

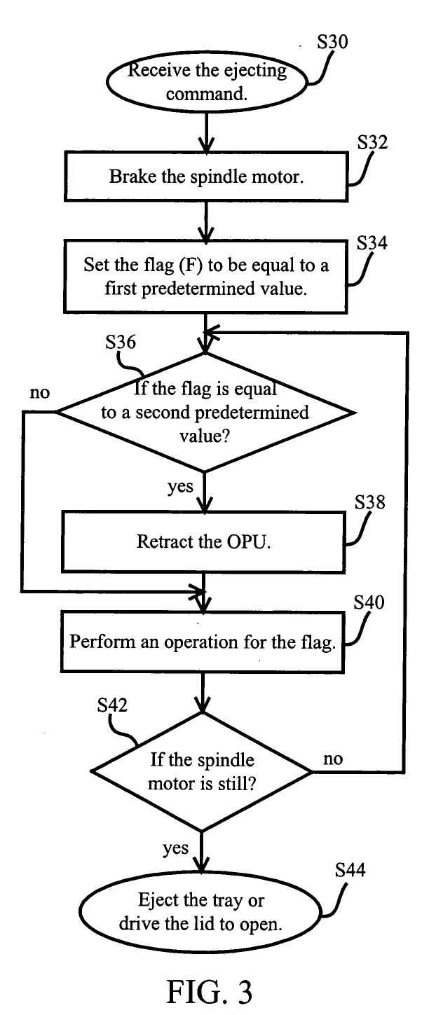

Please refer to FIG. 3. FIG. 3 is a flowchart of a preferred embodiment according to the present invention. In step S30 which is the beginning, the optical disk driver receives an ejecting command. Then, in step S32, the spindle motor is braked, e.g. a reverse voltage is added to decelerate the spindle motor. In step S34, a flag (F) is set to be equal to a first predetermined value. For example, the flag (F) is set to be 100 or 1.

After step S34, step S36 is performed to judge if the flag (F) is equal to a second predetermined value. If it is a YES in step S36, step S38 is performed to retract the OPU. If it is a NO in step S36 or after step S38, step S40 is performed to perform an operation on the flag (F).

In one embodiment, the flag (F) is equal to the second predetermined value when the operation for the flag (F) is performed for N times, wherein N is a positive integer.

In one embodiment, the operation for the flag (F) in step 40 is as follows:
F=F−I, wherein I is a predetermined variable, e.g. I is equal to 1.

Take the above operation as an example, the flag (F) is set to be equal to 100, and the second predetermined value is also equal to 100; I is set to be equal to 1, and N is equal to 0. In other words, when step S36 is performed for the first time, the result is YES. For another example, the flag (F) is set to be equal to 100, and the second predetermined value is equal to 91; I is set to be equal to 1, and N is equal to 10. In other words, when step S36 is performed for the 10^{th} time, the result is YES.

In another embodiment, the operation for the flag (F) in step 40 is as follows:
F=F+I, wherein I is a predetermined variable, e.g. I is equal to 1.

After step S40, step S42 is performed to detect if the spindle motor is still. If it is a NO in step S42, i.e. the spindle motor is not still yet, go back to step S36. If it is a YES in step S42, i.e. the spindle motor is still, step S44 is performed sequentially. In step S44, the tray is ejected out of the optical disk driver, or the lid is driven to rotate from the closed position to the open position with respect to the optical disk driver. After all of the above steps, the whole cycle of control steps in response to the ejecting command is completed.

Obviously, the difference between the prior art and the method of the present invention is that the OPU is retracted before the spindle motor is detected if it is still at the first time or in earlier process, so as to avoid wasting time. Proven by practical tests, according to the method of the present invention, the time needed by the whole cycle of control steps is reduced to at least 300 milliseconds.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A method for controlling an optical disk driver in response to an ejecting command requesting a tray, movably seated within said optical disk driver, to eject out of said optical disk driver, said optical disk driver also comprising a spindle motor and an optical pick-up unit (OPU), said method comprising the steps of:
(a) braking the spindle motor;
(b) setting a flag (F) equal to a first predetermined value;
(c) judging if the flag (F) is equal to a second predetermined value, and if YES, retracting the OPU;
(d) performing an operation on the flag;
(e) detecting if the spindle motor is still;
(e1) if NO in step (e), repeating steps (c) through (e); and
(e2) if YES in step (e), ejecting the tray, seated within said optical disk driver, out of said optical disk driver.

2. The method of claim 1, wherein the flag (F) is equal to the second predetermined value when the operation for the flag (F) is performed for N times, N is a positive integer.

3. The method of claim 2, wherein in step (d), the operation for the flag (F) is as follows:
F=F−I, wherein I is a predetermined variable.

4. The method of claim 2, wherein in step (d), the operation for the flag (F) is as follows:
F=F+I, wherein I is a predetermined variable.

5. A method for controlling an optical disk driver in response to an ejecting command requesting a lid, pivotally mounted onto said optical disk driver, to rotate from a closed position to an open position with respect to said optical disk driver, said optical disk driver also comprising a spindle motor and an optical pick-up unit (OPU), said method comprising the steps of:
(a) braking the spindle motor;
(b) setting a flag (F) equal to a first predetermined value;
(c) judging if the flag (F) is equal to a second predetermined value, and if YES, retracting the OPU;
(d) performing an operation for the flag;
(e) detecting if the spindle motor is still;
(e1) if NO in step (e), repeating steps (c) through (e); and
(e2) if YES in step (e), driving the lid rotating form the closed position to the open position with respect to said optical disk driver.

6. The method of claim 5, wherein the flag (F) is equal to the second predetermined value when the operation for the flag (F) is performed for N times, N is a positive integer.

7. The method of claim 6, wherein in step (d), the operation for the flag (F) is as follows:
F=F−I, wherein I is a predetermined variable.

8. The method of claim 6, wherein in step (d), the operation for the flag (F) is as follows:
F=F+I, wherein I is a predetermined variable.

9. A method for controlling an optical disk driver in response to an ejecting command requesting said optical disk driver, being operated in a closed state where an optical disk is disposed within said optical disk driver and capable of being driven, to be operated in an open state where the optical disk is disposed so as to be taken out by a user, said optical disk driver comprising a spindle motor and an optical pick-up unit (OPU), said method comprising the steps of:
(a) braking the spindle motor;
(b) setting a flag (F) equal to a first predetermined value;
(c) judging if the flag (F) is equal to a second predetermined value, and if YES, retracting the OPU;
(d) performing an operation on the flag;
(e) detecting if the spindle motor is still;
(e1) if NO in step (e), repeating steps (c) through (e); and
(e2) if YES in step (e), disposing the optical disk so as to be taken out by the user.

10. The method of claim 9, wherein the flag (F) is equal to the second predetermined value when the operation for the flag (F) is performed for N times, N is a positive integer.

11. The method of claim 10, wherein in step (d), the operation for the flag (F) is as follows:
F=F−I, wherein I is a predetermined variable.

12. The method of claim 10, wherein in step (d), the operation for the flag (F) is as follows:
F=F+I, wherein I is a predetermined variable.
